(19) United States
(12) Patent Application Publication
(10) Pub. No.: US 2017/0168415 A1
(43) Pub. Date: Jun. 15, 2017

(54) ELECTRICALLY CONDUCTIVE RUBBER COMPOSITION, AND DEVELOPING ROLLER

(71) Applicant: SUMITOMO RUBBER INDUSTRIES, LTD., Kobe-shi (JP)

(72) Inventors: Kenichi KURODA, Kobe-shi (JP); Kei TAJIMA, Kobe-shi (JP)

(73) Assignee: SUMITOMO RUBBER INDUSTRIES, LTD., Kobe-shi (JP)

(21) Appl. No.: 15/365,364

(22) Filed: Nov. 30, 2016

(30) Foreign Application Priority Data
Dec. 14, 2015 (JP) 2015-243326

(51) Int. Cl. B32B 9/04

(52) U.S. Cl. CPC G03G 15/0808

(57) ABSTRACT

An electrically conductive rubber composition is provided, which is usable for production of a developing roller imparted with proper flexibility without the use of a softening agent without the formation of a shield layer and permits the developing roller to form an image substantially free from image forming defects such as banding and fogging. A developing roller employing the electrically conductive rubber composition is also provided. The electrically conductive rubber composition contains a rubber component including only four types of rubbers, i.e., an epichlorohydrin rubber, a butadiene rubber, a chloroprene rubber and an acrylonitrile butadiene rubber, and a crosslinking component including 0.75 to 2.25 parts by mass of sulfur and 0.25 to 0.75 parts by mass of a thiuram accelerating agent based on 100 parts by mass of the overall rubber component. The developing roller (1) is produced from the electrically conductive rubber composition.

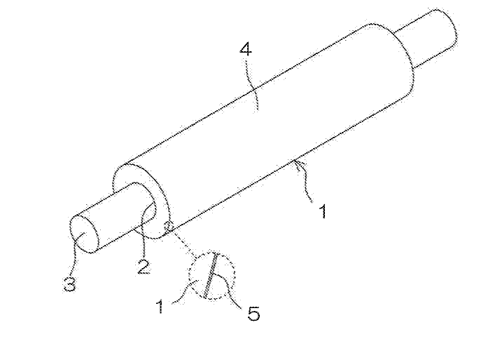

### TECHNICAL FIELD

The present invention relates to an electrically conductive rubber composition, and to a developing roller produced by using the same.

### BACKGROUND ART

In an electrophotographic image forming apparatus such as a laser printer, an electrostatic copying machine, a plain paper facsimile machine or a printer-copier-facsimile multifunction machine, an image is generally formed on a surface of a sheet such as a paper sheet or a plastic film through the following process steps.

In the following description, a photoreceptor body having photoelectric conductivity is used as an electrostatic latent image carrier for carrying an electrostatic latent image fundamental to image formation by way of example but not byway of limitation.

First, a surface of the photoreceptor body is evenly electrically charged and, in this state, exposed to light, whereby an electrostatic latent image corresponding to an image to be formed on the sheet is formed on the surface of the photoreceptor body (charging step and exposing step).

Then, toner (minute color particles) preliminarily electrically charged at a predetermined potential is brought into contact with the surface of the photoreceptor body. Thus, the toner selectively adheres to the surface of the photoreceptor body according to the potential pattern of the electrostatic latent image, whereby the electrostatic latent image is developed into a toner image (developing step).

Subsequently, the toner image formed by the development is transferred onto the surface of the sheet (transfer step), and fixed to the surface of the sheet (fixing step). Thus, the image is formed on the surface of the sheet.

Further, a part of the toner remaining on the surface of the photoreceptor body after the transfer of the toner image is removed (cleaning step). Thus, the photoreceptor body is ready for the next image formation.

In the developing step out of the aforementioned process steps, a developing roller is used for developing the electrostatic latent image formed on the surface of the photoreceptor body into the toner image.

The developing roller is disposed in contact with the surface of the photoreceptor body with a predetermined contact width or disposed adjacent to the surface of the photoreceptor body. The developing roller carries a thin toner layer formed on an outer peripheral surface thereof by a coating blade or the like and, in this state, is rotated to bring the thin layer into contact with the electrostatic latent image formed on the surface of the photoreceptor body. With this mechanism, the developing roller functions to develop the electrostatic latent image into the toner image.

The developing roller is required to be flexible and deformable, to prevent the contamination of the photoreceptor body, and to permit production thereof at lower costs.

The developing roller is generally produced by forming a rubber composition imparted with electrical conductivity (electrically conductive rubber composition) into a tubular body and crosslinking the tubular body.

For example, Patent Document 1 discloses a developing roller formed from an electrically conductive rubber composition imparted with electrical conductivity by blending carbon black with a rubber component and imparted with flexibility by blending a softening agent such as a plasticizer with the rubber component.

Further, Patent Document 2 discloses a developing roller having an outer peripheral surface covered with a shield layer for preventing a bleed substance such as a softening agent from bleeding from the developing roller to suppress the contamination of the photoreceptor body and an adverse effect on image formation.

The shield layer described in Patent Document 2 is formed by applying a liquid coating agent such as containing a given resin or rubber on the outer peripheral surface of the developing roller and drying the coating agent and, if the resin or the rubber is crosslinkable, crosslinking the coating agent. Therefore, the following problems arise.

The shield layer is liable to have a greater thickness and a higher hardness, so that the developing roller is liable to have lower flexibility. In addition, the shield layer is problematically liable to suffer from contamination with foreign matter such as dust, thickness unevenness and other inconveniences during the formation thereof.

In Patent Document 2, where the developing roller is mainly formed of a silicone rubber or the like, the surface of the developing roller is pretreated for formation of a primer layer prior to the formation of the shield layer in order to improve the adhesiveness of the shield layer to the developing roller. However, this arrangement increases the number of process steps to reduce the productivity of the developing roller. Problematically, the number of the layers of the overall developing roller is increased to further reduce the flexibility of the developing roller.

To cope with this, it is contemplated to impart the developing roller with sufficient flexibility without the use of the bleed substance (e.g., a softening agent such as a plasticizer or a process oil), for example, by proper selection of rubbers to be used in combination as a rubber component, thereby obviating the shield layer.

### CITATION LIST

### Patent Document

Patent Document 1: JP2007-333857A

Patent Document 2: JP2005-215485A

### SUMMARY OF THE INVENTION

### Problem to be Solved by the Invention

According to studies conducted by the inventor of the present invention, the developing roller imparted with the flexibility without the use of the softening agent, for example, by the proper selection of the rubbers to be used in combination as the rubber component is problematically liable to cause a so-called banding defect, i.e., image density variation which may occur, for example, in a solid image portion or a halftone image portion due to uneven rotation and the like of a developing roller driving mechanism. Further, the developing roller is problematically liable to cause a so-called fogging defect, i.e., adhesion of toner on a margin of a formed image due to reduction in imaging durability when the image formation is repeated.

The banding is caused supposedly because vibrations of the developing roller occurring due to the uneven rotation and the like cannot be sufficiently absorbed when the developing roller has lower elasticity and higher viscosity.

The fogging due to the reduction in imaging durability occurs when the flexibility of the developing roller is insufficient.

That is, a very small part of toner contained in a developing section of the image forming apparatus is used in each image forming cycle, and the remaining major part of the toner is repeatedly circulated in the developing section.

Therefore, if the developing roller provided in the developing section has insufficient flexibility, the toner is liable to be damaged when being repeatedly brought into contact with the developing roller in the repeated image formation.

If the percentage of the toner damaged to be broken into particles is increased, the chargeability of the broken toner particles are significantly deviated from that of normal toner, so that the toner is more liable to adhere to the margin of the formed image to cause the fogging.

It is an object of the present invention to provide an electrically conductive rubber composition which is usable for production of a developing roller imparted with proper flexibility without the use of the softening agent without the formation of the shield layer and permits the developing roller to form an image substantially free from the banding, the fogging and other defects, and to provide a developing roller produced by using the electrically conductive rubber composition.

### Solution to Problem

According to an inventive aspect, there is provided an electrically conductive rubber composition containing a rubber component, and a crosslinking component for crosslinking the rubber component, wherein the rubber component includes an epichlorohydrin rubber, a butadiene rubber, a chloroprene rubber and an acrylonitrile butadiene rubber, wherein the crosslinking component includes not less than 0.75 parts by mass and not greater than 2.25 parts by mass of sulfur and not less than 0.25 parts by mass and not greater than 0.75 parts by mass of a thiuram accelerating agent based on 100 parts by mass of the overall rubber component.

According to another inventive aspect, there is provided a developing roller made of a crosslinking product of the inventive electrically conductive rubber composition.

### Effects of the Invention

According to the present invention, the electrically conductive rubber composition is usable for production of a developing roller imparted with proper flexibility without the use of the softening agent without the formation of the shield layer and permits the developing roller to form an image substantially free from the banding, the fogging and other defects. Further, the developing roller produced by using the electrically conductive rubber composition is provided.

### BRIEF DESCRIPTION OF THE DRAWINGS

FIGURE is a perspective view illustrating an exemplary developing roller according to one embodiment of the present invention.

### EMBODIMENTS OF THE INVENTION

### <<Electrically Conductive Rubber Composition>>

The inventive electrically conductive rubber composition contains a rubber component, and a crosslinking component for crosslinking the rubber component. The rubber component includes an epichlorohydrin rubber, a butadiene rubber (BR), a chloroprene rubber (CR) and an acrylonitrile butadiene rubber (NBR). The crosslinking component includes not less than 0.75 parts by mass and not greater than 2.25 parts by mass of sulfur and not less than 0.25 parts by mass and not greater than 0.75 parts by mass of a thiuram accelerating agent based on 100 parts by mass of the overall rubber component.

The inventive electrically conductive rubber composition contains the ion conductive epichlorohydrin rubber as the rubber component to thereby impart a developing roller with proper electrical conductivity. The electrically conductive rubber composition further contains the BR, the CR and the NBR as the rubber component to thereby impart the developing roller with excellent rubber characteristic properties, particularly with proper flexibility, even if having a formulation not containing the softening agent (or excluding the softening agent).

The crosslinking component includes the sulfur as a crosslinking agent and the thiuram accelerating agent in the aforementioned proportions, whereby the crosslinking state of the rubber component including the four types of rubbers is properly controlled. This substantially prevents a formed image from suffering from the banding and the fogging.

### <Rubber Component>

As described above, only the four types of rubbers, i.e., the epichlorohydrin rubber, the BR, the CR and the NBR, are used in combination as the rubber component. The four types of rubbers may each include two or more rubbers.

### (Epichlorohydrin Rubber)

Various ion-conductive polymers each containing epichlorohydrin as a repeating unit to impart the developing roller with proper electrical conductivity are usable as the epichlorohydrin rubber.

Examples of the epichlorohydrin rubber include epichlorohydrin homopolymers, epichlorohydrin-ethylene oxide bipolymers (ECO), epichlorohydrin-propylene oxide bipolymers, epichlorohydrin-allyl glycidyl ether bipolymers, epichlorohydrin-ethylene oxide-allyl glycidyl ether terpolymers (GECO), epichlorohydrin-propylene oxide-allyl glycidyl ether terpolymers and epichlorohydrin-ethylene oxide-propylene oxide-allyl glycidyl ether quaterpolymers, which may be used alone or in combination.

Of these epichlorohydrin rubbers, the ethylene oxide-containing copolymers, particularly the ECO and/or the GECO are preferred.

These copolymers preferably each have an ethylene oxide content of not less than 30 mol % and not greater than 80 mol %, particularly preferably not less than 50 mol %.

Ethylene oxide functions to reduce the roller resistance of the developing roller (which is an index of the electrical conductivity of the developing roller) to improve the electrical conductivity of the developing roller. If the ethylene oxide content is less than the aforementioned range, however, it will be impossible to sufficiently provide this function and hence to sufficiently reduce the roller resistance.

If the ethylene oxide content is greater than the aforementioned range, on the other hand, ethylene oxide is liable to be crystallized, whereby the segment motion of molecular chains is hindered to adversely increase the roller resistance. Further, the developing roller is liable to have an excessively high hardness after the crosslinking, and the electrically conductive rubber composition is liable to have a higher viscosity and, hence, poorer processability when being heat-melted before the crosslinking.

The ECO has an epichlorohydrin content that is a balance obtained by subtracting the ethylene oxide content from the total. That is, the epichlorohydrin content is preferably not less than 20 mol % and not greater than 70 mol %, particularly preferably not greater than 50 mol %.

The GECO preferably has an allyl glycidyl ether content of not less than 0.5 mol % and not greater than 10 mol %, particularly preferably not less than 2 mol % and not greater than 5 mol %.

Allyl glycidyl ether per se functions as side chains of the copolymer to provide a free volume, whereby the crystallization of ethylene oxide is suppressed to reduce the roller resistance of the developing roller. However, if the allyl glycidyl ether content is less than the aforementioned range, it will be impossible to sufficiently provide this function and hence to sufficiently reduce the roller resistance.

Allyl glycidyl ether also functions as crosslinking sites during the crosslinking of the GECO. Therefore, if the allyl glycidyl ether content is greater than the aforementioned range, the crosslinking density of the GECO is excessively increased, whereby the segment motion of molecular chains is hindered to adversely increase the roller resistance.

The GECO has an epichlorohydrin content that is a balance obtained by subtracting the ethylene oxide content and the allyl glycidyl ether content from the total. That is, the epichlorohydrin content is preferably not less than 10 mol % and not greater than 69.5 mol %, particularly preferably not less than 19.5 mol % and not greater than 60 mol %.

Examples of the GECO include copolymers of the three comonomers described above in a narrow sense, as well as known modification products obtained by modifying an epichlorohydrin-ethylene oxide copolymer (ECO) with allyl glycidyl ether. In the present invention, any of these modification products may be used as the GECO.

These epichlorohydrin rubbers maybe used alone or in combination.

### (BR)

The BR functions to impart the developing roller with excellent rubber characteristic properties, i.e., to make the developing roller flexible and less susceptible to permanent compressive deformation with a reduced compression set.

The BR also functions to improve the toner chargeability, particularly, for positively chargeable toner.

Further, the BR functions as a material to be oxidized by irradiation with ultraviolet radiation in an oxidizing atmosphere, as will be described later, to form an oxide film in an outer peripheral surface of the developing roller.

Usable as the BR are various crosslinkable BRs each having a polybutadiene structure in a molecule thereof.

Particularly, a higher cis-content BR having a cis-1,4 bond content of not less than 95% and excellent rubber characteristic properties in a temperature range from a higher temperature to a lower temperature is preferred.

The BRs include those of an oil-extension type having flexibility controlled by addition of an extension oil, and those of a non-oil-extension type containing no extension oil. In the present invention, a non-oil-extension type BR which does not contain the extension oil (which may be a bleed substance) is preferably used for prevention of the contamination of the photoreceptor body.

These BRs may be used alone or in combination.

### (CR)

Particularly, the CR functions to improve the flexibility of the developing roller.

Further, the CR functions to improve the toner chargeability, particularly, for positively chargeable toner. Since the CR is a polar rubber, the CR also functions to finely control the roller resistance of the developing roller.

The CR also functions as a material to be oxidized by irradiation with ultraviolet radiation in an oxidizing atmosphere to form the oxide film in the outer peripheral surface of the developing roller.

The CR is synthesized, for example, by emulsion polymerization of chloroprene, and may be classified in a sulfur modification type or a non-sulfur-modification type depending on the type of a molecular weight adjusting agent to be employed for the emulsion polymerization.

The sulfur modification type CR is prepared by plasticizing a copolymer of chloroprene and sulfur (molecular weight adjusting agent) with thiuram disulfide or the like to adjust the viscosity of the copolymer to a predetermined viscosity level.

The non-sulfur-modification type CR may be classified, for example, in a mercaptan modification type, a xanthogen modification type or the like.

The mercaptan modification type CR is synthesized in substantially the same manner as the sulfur modification type CR, except that an alkyl mercaptan such as n-dodecyl mercaptan, tert-dodecyl mercaptan or octyl mercaptan, for example, is used as the molecular weight adjusting agent. The xanthogen modification type CR is synthesized in substantially the same manner as the sulfur modification type CR, except that an alkyl xanthogen compound is used as the molecular weight adjusting agent.

Further, the CR may be classified in a lower crystallization speed type, an intermediate crystallization speed type or a higher crystallization speed type depending on the crystallization speed.

In the present invention, any of the aforementioned types of CRs may be used. Particularly, a CR of the non-sulfur-modification type and the lower crystallization speed type is preferred.

Further, a copolymer of chloroprene and other comonomer may be used as the CR. Examples of the other comonomer include 2,3-dichloro-1,3-butadiene, 1-chloro-1,3-butadiene, styrene, acrylonitrile, methacrylonitrile, isoprene, butadiene, acrylic acid, acrylates, methacrylic acid and methacrylates, which may be used alone or in combination.

The CRs include those of an oil-extension type having flexibility controlled by addition of an extension oil, and those of a non-oil-extension type containing no extension oil. In the present invention, a non-oil-extension type CR which does not contain the extension oil (which may be a bleed substance) is preferably used for prevention of the contamination of the photoreceptor body.

These CRs may be used alone or in combination.

### (NBR)

The NBR has a solubility parameter (SP value) that is close to those of the epichlorohydrin rubber, the BR and the CR. Therefore, the NBR functions as a so-called compatibilizer to assist the fine dispersion of the rubbers. Thus, the electrically conductive rubber composition has an improved fluidity in a heated state, and ensures satisfactory processability and further improves the flexibility of the developing roller even without the use of the softening agent.

The NBR is also a polar rubber and, therefore, functions to finely control the roller resistance of the developing roller.

Further, the NBR also functions as a material to be oxidized by irradiation with ultraviolet radiation in an oxidizing atmosphere to form an oxide film in an outer peripheral surface of the developing roller.

The NBR may be classified in a lower acrylonitrile content type having an acrylonitrile content of not greater than 24%, an intermediate acrylonitrile content type having an acrylonitrile content of 25 to 30%, an intermediate and higher acrylonitrile content type having an acrylonitrile content of 31 to 35%, a higher acrylonitrile content type having an acrylonitrile content of 36 to 42%, or a very high acrylonitrile content type having an acrylonitrile content of not lower than 43%. Any of these types of NBRs are usable.

An NBR having a lower Mooney viscosity is preferably selected for use in order to impart the electrically conductive rubber composition with improved fluidity in a heated state and with further satisfactory processability even without the use of the softening agent. More specifically, the NBR preferably has a Mooney viscosity ML₁₊₄ (100° C.) of not greater than 35.

The lower limit of the Mooney viscosity is not particularly limited, and an NBR having the lowest available Mooney viscosity may be used. Further, various solid NBRs are usable. Instead of the solid NBRs, liquid NBRs which are liquid at an ordinary temperature are also usable.

The NBRs include those of an oil-extension type having flexibility controlled by addition of an extension oil, and those of a non-oil-extension type containing no extension oil. In the present invention, a non-oil-extension type NBR which does not contain the extension oil (which may be a bleed substance) is preferably used for prevention of the contamination of the photoreceptor body.

These NBRs may be used alone or in combination.

### (Proportions of Rubbers to be Blended)

The proportions of the four types of rubbers to be blended as the rubber component may be properly determined according to the required properties of the developing roller, particularly the electrical conductivity and the flexibility of the developing roller.

The proportion of the epichlorohydrin rubber to be blended is preferably not less than 30 parts by mass and not greater than 50 parts by mass, particularly preferably not less than 35 parts by mass and not greater than 45 parts by mass, based on 100 parts by mass of the overall rubber component.

If the proportion of the epichlorohydrin rubber is less than the aforementioned range, it will be impossible to impart the developing roller with proper electrical conductivity.

If the proportion of the epichlorohydrin rubber is greater than the aforementioned range, on the other hand, the proportions of the other rubbers are relatively reduced, making it impossible to impart the electrically conductive rubber composition with satisfactory processability or to impart the developing roller with proper rubber characteristic properties, particularly with higher flexibility. Further, the developing roller is liable to suffer from adhesion of toner to thereby reduce the image density.

Where the proportion of the epichlorohydrin rubber falls within the aforementioned range, in contrast, it is possible to impart the developing roller with proper electrical conductivity while providing the effect of the use of the epichlorohydrin rubber in combination with the other three rubbers.

The proportion of the BR to be blended is basically a balance obtained by subtracting the proportions of the other three rubbers from the total. That is, the proportion of the BR is such that the predetermined proportions of the epichlorohydrin rubber, the CR and the NBR plus the proportion of the BR equal to 100 parts by mass of the overall rubber component.

The proportion of the BR is preferably not less than 30 parts by mass and not greater than 50 parts by mass, particularly preferably not less than 35 parts by mass and not greater than 45 parts by mass, based on 100 parts by mass of the overall rubber component.

If the proportion of the BR is less than the aforementioned range, it will be impossible to impart the developing roller with proper rubber characteristic properties.

If the proportion of the BR is greater than the aforementioned range, on the other hand, the proportion of the epichlorohydrin rubber is relatively reduced, making it impossible to impart the developing roller with proper electrical conductivity. Further, the proportions of the CR and the NBR are reduced, making it impossible to impart the electrically conductive rubber composition with satisfactory processability and to impart the developing roller with proper flexibility.

Where the proportion of the BR falls within the aforementioned range, in contrast, it is possible to impart the developing roller with proper rubber characteristic properties while providing the effect of the use of the BR in combination with the other three rubbers.

The proportion of the CR is preferably not less than 5 parts by mass and not greater than 15 parts by mass based on 100 parts by mass of the overall rubber component.

If the proportion of the CR is less than the aforementioned range, it will be impossible to impart the developing roller with proper flexibility.

If the proportion of the CR is greater than the aforementioned range, on the other hand, the proportion of the epichlorohydrin rubber is relatively reduced, making it impossible to impart the developing roller with proper electrical conductivity. Further, the proportion of the BR is reduced, making it impossible to impart the developing roller with proper rubber characteristic properties. Further, the proportion of the NBR is reduced, making it impossible to impart the electrically conductive rubber composition with satisfactory processability and to impart the developing roller with proper flexibility.

Where the proportion of the CR falls within the aforementioned range, in contrast, it is possible to impart the developing roller with proper flexibility while providing the effect of the use of the CR in combination with the other three rubbers.

The proportion of the NBR is preferably not less than 5 parts by mass and not greater than 15 parts by mass based on 100 parts by mass of the overall rubber component.

If the proportion of the NBR is less than the aforementioned range, it will be impossible to impart the electrically conductive rubber composition with satisfactory processability or to impart the developing roller with proper flexibility.

If the proportion of the NBR is greater than the aforementioned range, on the other hand, the proportion of the epichlorohydrin rubber is relatively reduced, making it impossible to impart the developing roller with proper electrical conductivity. Further, the proportion of the BR is reduced, making it impossible to impart the developing roller with proper rubber characteristic properties. Further, the proportion of the CR is reduced, making it impossible to impart the developing roller with proper flexibility.

Where the proportion of the NBR falls within the aforementioned range, in contrast, it is possible to impart the electrically conductive rubber composition with satisfactory processability and to impart the developing roller with proper flexibility while providing the effect of the use of the NBR in combination with the other three rubbers.

### <Crosslinking Component>

As described above, at least the sulfur and the thiuram accelerating agent are used in combination as the crosslinking component.

Various types of sulfur functioning as a crosslinking agent for the rubber component are usable as the sulfur.

Examples of the thiuram accelerating agent include tetramethylthiuram monosulfide (TMTM), tetramethylthiuram disulfide (TMTD), tetraethylthiuram disulfide (TETD), tetrabutylthiuram disulfide (TBTD) and dipentamethylenethiuram tetrasulfide (DPTT), which may be used alone or in combination.

The proportion of the sulfur to be blended is limited to not less than 0.75 parts by mass and not greater than 2.25 parts by mass based on 100 parts by mass of the overall rubber component, and the proportion of the thiuram accelerating agent to be blended is limited to not less than 0.25 parts by mass and not greater than 0.75 parts by mass based on 100 parts by mass of the overall rubber component.

If either of the proportions of the sulfur and the thiuram accelerating agent is less than the aforementioned corresponding range, the developing roller is liable to have a smaller elasticity and a greater viscosity with an insufficient crosslinking density. Therefore, when the image formation is performed with the developing roller incorporated in an image forming apparatus, the banding defect is liable to occur due to the uneven rotation and the like of a developing roller driving mechanism.

If either of the proportions of the sulfur and the thiuram accelerating agent is greater than the aforementioned corresponding range, on the other hand, the developing roller is liable to have insufficient flexibility with an excessively high crosslinking density. Therefore, when the image formation is repeatedly performed with the developing roller incorporated in the image forming apparatus, the fogging defect is liable to occur in a margin of a formed image.

Where the proportions of the sulfur and the thiuram accelerating agent respectively fall within the aforementioned ranges, in contrast, it is possible to impart the developing roller with proper flexibility by using the four types of rubbers as the rubber component without the use of the softening agent without the formation of the shield layer. In addition, an image formed with the use of the developing roller is substantially free from the banding, the fogging and other defects.

For further improvement of these effects, the total proportion of the sulfur and the thiuram accelerating agent is preferably not less than 1.3 parts by mass and not greater than 3.0 parts by mass, particularly preferably not less than 1.5 parts by mass and not greater than 2.5 parts by mass, based on 100 parts by mass of the overall rubber component.

Where a sulfur crosslinking agent such as treated with other substance, e.g., oil-containing sulfur powder or dispersive sulfur, is used as the sulfur, the proportion of the sulfur is the effective proportion of sulfur contained in the sulfur crosslinking agent.

An additional accelerating agent may be used together with the sulfur and the thiuram accelerating agent as the crosslinking component.

Examples of the additional accelerating agent include a thiazole accelerating agent, a thiourea accelerating agent and a guanidine accelerating agent, which may be used alone or in combination. Since different types of accelerating agents have different crosslinking accelerating mechanisms, these three types of accelerating agents are preferably used in combination.

Examples of the thiazole accelerating agent include 2-mercaptobenzothiazole (MBT), di-2-benzothiazolyl disulfide (MBTS), a zinc salt of 2-mercaptobenzothiazole (ZnMBT), a cyclohexylamine salt of 2-mercaptobenzothiazole (CMBT), and 2-(4′-morpholinodithio)benzothiazole (MDB), which may be used alone or in combination.

The proportion of the thiazole accelerating agent to be blended is preferably not less than 0.75 parts by mass and not greater than 2 parts by mass based on 100 parts by mass of the overall rubber component in order to further improve the aforementioned effects of the present invention by using the sulfur, the thiuram accelerating agent, the thiourea accelerating agent and the guanidine accelerating agent in combination with the thiazole accelerating agent.

Examples of the thiourea accelerating agent include ethylene thiourea (2-mercaptoimidazoline, EU), N,N′-diethylthiourea (DEU) and N,N′-dibutylthiourea, which may be used alone or in combination.

The proportion of the thiourea accelerating agent to be blended is preferably not less than 0.5 parts by mass and not greater than 1.5 parts by mass based on 100 parts by mass of the overall rubber component in order to further improve the aforementioned effects of the present invention by using the sulfur, the thiuram accelerating agent, the thiazole accelerating agent and the guanidine accelerating agent in combination with the thiourea accelerating agent.

Examples of the guanidine accelerating agent include 1,3-diphenylguanidine (DPG), 1,3-di-o-tolylguanidine (DOTG), 1-o-tolylbiguanide (OTBG) and a di-o-tolylguanidine salt of dicatechol borate, which may be used alone or in combination.

The proportion of the guanidine accelerating agent to be blended is preferably not less than 0.1 part by mass and not greater than 1 part by mass, particularly preferably not less than 0.55 parts by mass, based on 100 parts by mass of the overall rubber component in order to further improve the aforementioned effects of the present invention by using the sulfur, the thiuram accelerating agent, the thiazole accelerating agent and the thiourea accelerating agent in combination with the guanidine accelerating agent.

### <Other Ingredients>

As required, various additives may be added to the inventive electrically conductive rubber composition.

Examples of the additives include an acceleration assisting agent, an acid accepting agent, a processing aid, a degradation preventing agent, a filler, an anti-scorching agent, a pigment, an anti-static agent, a flame retarder, a neutralizing agent, a nucleating agent and a co-crosslinking agent.

In order to prevent the contamination of the photoreceptor body without the formation of the shield layer, however, it is preferred that the electrically conductive rubber composition does not contain (excludes) the softening agent such as a plasticizer and oil.

Examples of the acceleration assisting agent include metal compounds such as zinc oxide (zinc white), fatty acids such as stearic acid, oleic acid and cotton seed fatty acids, and other conventionally known acceleration assisting agents, which may be used alone or in combination.

The proportion of the acceleration assisting agent to be blended is preferably not less than 0.5 parts by mass and not greater than 7 parts by mass based on 100 parts by mass of the overall rubber component.

In the presence of the acid accepting agent, chlorine-containing gases generated from the epichlorohydrin rubber and the CR during the crosslinking of the rubber component are prevented from remaining in the developing roller. Thus, the acid accepting agent functions to prevent the inhibition of the crosslinking and the contamination of the photoreceptor body, which may otherwise be caused by the chlorine-containing gases.

Any of various substances serving as acid acceptors may be used as the acid accepting agent. Preferred examples of the acid accepting agent include hydrotalcites and Magsarat which are excellent in dispersibility. Particularly, the hydrotalcites are preferred.

Where the hydrotalcites are used in combination with magnesium oxide or potassium oxide, a higher acid accepting effect can be provided, thereby more reliably preventing the inhibition of the crosslinking and the contamination of the photoreceptor body.

The proportion of the acid accepting agent to be blended is preferably not less than 0.5 parts by mass and less than 2.5 parts by mass, particularly preferably not less than 1 part by mass and not greater than 2 parts by mass, based on 100 parts by mass of the overall rubber component.

If the proportion of the acid accepting agent is less than the aforementioned range, it will be impossible to sufficiently provide the effect of the blending of the acid accepting agent. If the proportion of the acid accepting agent is greater than the aforementioned range, it will be impossible to impart the developing roller with proper flexibility.

Examples of the processing aid include metal salts of fatty acids such as zinc stearate.

The proportion of the processing aid to be blended is preferably not less than 0.1 part by mass and not greater than 1 part by mass, particularly preferably not greater than 0.5 parts by mass, based on 100 parts by mass of the overall rubber component.

Examples of the degradation preventing agent include various anti-aging agents and anti-oxidants.

The anti-oxidants serve to reduce the environmental dependence of the roller resistance of the developing roller and to suppress the increase in roller resistance during continuous energization of the developing roller. Examples of the anti-oxidants include nickel diethyldithiocarbamate and nickel dibutyldithiocarbamate.

Examples of the filler include titanium oxide, zinc oxide, silica, carbon, carbon black, clay, talc, calcium carbonate, magnesium carbonate and aluminum hydroxide, which may be used alone or in combination.

The blending of the filler improves the mechanical strength and the like of the developing roller.

The proportion of the filler to be blended is preferably not less than 2 parts by mass and not greater than 20 parts by mass based on 100 parts by mass of the overall rubber component.

An electrically conductive filler such as electrically conductive carbon black may be blended as the filler to impart the developing roller with electron conductivity.

A particularly preferred example of the electrically conductive carbon black is particulate acetylene black. The particulate acetylene black is easy to handle. In addition, the acetylene black can be homogenously dispersed in the electrically conductive rubber composition, making it possible to impart the developing roller with more uniform electron conductivity.

The proportion of the electrically conductive carbon black to be blended is preferably not less than 1 part by mass and not greater than 10 parts by mass, particularly preferably not less than 3 parts by mass and not greater than 8 parts by mass, based on 100 parts by mass of the overall rubber component.

Examples of the anti-scorching agent include N-cyclohexylthiophthalimide, phthalic anhydride, N-nitrosodiphenylamine and 2,4-diphenyl-4-methyl-1-pentene, which may be used alone or in combination. Particularly, N-cyclohexylthiophthalimide is preferred.

The proportion of the anti-scorching agent to be blended is preferably not less than 0.1 part by mass and not greater than 5 parts by mass based on 100 parts by mass of the overall rubber component.

The co-crosslinking agent serves to crosslink itself as well as the rubber component to increase the overall molecular weight.

Examples of the co-crosslinking agent include ethylenically unsaturated monomers typified by methacrylic esters, metal salts of methacrylic acid and acrylic acid, polyfunctional polymers utilizing functional groups of 1,2-polybutadienes, and dioximes, which may be used alone or in combination.

Examples of the ethylenically unsaturated monomers include:
(a) monocarboxylic acids such as acrylic acid, methacrylic acid and crotonic acid;
(b) dicarboxylic acids such as maleic acid, fumaric acid and itaconic acid;
(c) esters and anhydrides of the unsaturated carboxylic acids (a) and (b);
(d) metal salts of the monomers (a) to (c);
(e) aliphatic conjugated dienes such as 1,3-butadiene, isoprene and 2-chloro-1,3-butadiene;
(f) aromatic vinyl compounds such as styrene, α-methylstyrene, vinyltoluene, ethylvinylbenzene and divinylbenzene;
(g) vinyl compounds such as triallyl isocyanurate, triallyl cyanurate and vinylpyridine each having a hetero ring; and
(h) cyanovinyl compounds such as (meth) acrylonitrile and α-chloroacrylonitrile, acrolein, formyl sterol, vinyl methyl ketone, vinyl ethyl ketone and vinyl butyl ketone. These ethylenically unsaturated monomers may be used alone or in combination.

Monocarboxylic acid esters are preferred as the esters (c) of the unsaturated carboxylic acids.

Specific examples of the monocarboxylic acid esters include:

alkyl (meth) acrylates such as methyl (meth) acrylate, ethyl (meth)acrylate, n-propyl (meth)acrylate, i-propyl (meth)acrylate, n-butyl (meth)acrylate, i-butyl (meth)acrylate, n-pentyl (meth)acrylate, i-pentyl (meth)acrylate, n-hexyl (meth)acrylate, cyclohexyl (meth)acrylate, 2-ethylhexyl (meth)acrylate, octyl (meth)acrylate, i-nonyl (meth)acrylate, tert-butylcyclohexyl (meth)acrylate, decyl (meth) acrylate, dodecyl (meth)acrylate, hydroxymethyl (meth)acrylate and hydroxyethyl (meth)acrylate;

aminoalkyl (meth)acrylates such as aminoethyl (meth)acrylate, dimethylaminoethyl (meth)acrylate and butylaminoethyl (meth)acrylate;

(meth)acrylates such as benzyl (meth)acrylate, benzoyl (meth)acrylate and aryl (meth)acrylates each having an aromatic ring;

(meth)acrylates such as glycidyl (meth)acrylate, methaglycidyl (meth)acrylate and epoxycyclohexyl (meth)acrylate each having an epoxy group;

(meth)acrylates such as N-methylol (meth)acrylamide, γ-(meth)acryloxypropyltrimethoxysilane and tetrahydrofurfuryl methacrylate each having a functional group; and

polyfunctional (meth)acrylates such as ethylene glycol di(meth)acrylate, trimethylolpropane tri(meth)acrylate, ethylene dimethacrylate (EDMA), polyethylene glycol dimethacrylate and isobutylene ethylene dimethacrylate. These monocarboxylic acid esters may be used alone or in combination.

The electrically conductive rubber composition containing the ingredients described above can be prepared in a conventional manner.

First, the four types of rubbers for the rubber component are blended in the predetermined proportions, and the resulting rubber component is simply kneaded. After additives other than the crosslinking component are added to and kneaded with the rubber component, the crosslinking component is finally added to and further kneaded with the resulting mixture. Thus, the electrically conductive rubber composition is provided.

A sealed kneading machine such as an Intermix mixer, a Banbury mixer, a kneader or an extruder, an open roll or the like, for example, is usable for the kneading.

### <<Developing Roller>>

FIGURE is a perspective view illustrating a developing roller according to one embodiment of the present invention.

Referring to FIGURE, the developing roller 1 according to this embodiment is a tubular body of a nonporous single-layer structure formed from the inventive electrically conductive rubber composition, and a shaft 3 is inserted through and fixed to a center through-hole 2 of the tubular body.

The shaft 3 is a unitary member made of a metal such as aluminum, an aluminum alloy or a stainless steel.

The shaft 3 is electrically connected to and mechanically fixed to the developing roller 1, for example, via an electrically conductive adhesive agent. Alternatively, a shaft having an outer diameter that is greater than the inner diameter of the through-hole 2 is used as the shaft 3, and press-inserted into the through-hole 2 to be electrically connected to and mechanically fixed to the developing roller 1. Thus, the shaft 3 and the developing roller 1 are unitarily rotatable.

The developing roller 1 may have an oxide film 5 provided in an outer peripheral surface 4 thereof as shown in FIGURE on an enlarged scale.

The oxide film 5 thus provided functions as a dielectric layer to reduce the dielectric dissipation factor of the developing roller 1. Further, the oxide film 5 serves as a lower friction layer which advantageously suppresses the adhesion of the toner.

In addition, the oxide film 5 can be easily formed, as described above, through the oxidation of the BR, the CR and the NBR of the electrically conductive rubber composition in the outer peripheral surface 4, for example, by irradiating the outer peripheral surface 4 with ultraviolet radiation in an oxidizing atmosphere. This suppresses the reduction in the productivity of the developing roller 1 and the increase in the production costs of the developing roller 1.

The term “single-layer structure” of the developing roller 1 means that the developing roller 1 includes a single rubber layer and the oxide film 5 formed by the irradiation with the ultraviolet radiation is not counted.

For production of the developing roller 1, the electrically conductive rubber composition preliminarily prepared is first extruded into a tubular body by means of an extruder. Then, the tubular body is cut to a predetermined length, and crosslinked in a vulcanization can by pressure and heat.

In turn, the crosslinked tubular body is heated in an oven or the like for secondary crosslinking, then cooled, and polished to a predetermined outer diameter.

Various polishing methods such as a dry traverse polishing method may be used for the polishing. Where the outer peripheral surface 4 is mirror-finished at the final stage of the polishing process, the outer peripheral surface 4 is improved in releasability, and is substantially free from the adhesion of the toner even without the formation of the oxide film 5. This effectively prevents the contamination of the photoreceptor body and the like.

Where the oxide film 5 is formed in the outer peripheral surface 4 after the mirror-finishing of the outer peripheral surface 4, the synergistic effect of the mirror-finishing and the formation of the oxide film 5 more advantageously suppresses the adhesion of the toner, and further advantageously prevents the contamination of the photoreceptor body and the like.

The shaft 3 may be inserted into and fixed to the through-hole 2 at any time between the end of the cutting of the tubular body and the end of the polishing.

However, the tubular body is preferably secondarily crosslinked and polished with the shaft 3 inserted through the through-hole 2 after the cutting. This prevents warpage and deformation of the developing roller 1 which may otherwise occur due to expansion and contraction of the tubular body in the secondary crosslinking. Further, the tubular body may be polished while being rotated about the shaft 3. This improves the working efficiency in the polishing, and suppresses deflection of the outer peripheral surface 4.

As previously described, the shaft 3 having an outer diameter greater than the inner diameter of the through-hole 2 may be press-inserted into the through-hole 2, or the shaft 3 may be inserted through the through-hole 2 of the tubular body with the intervention of an electrically conductive thermosetting adhesive agent before the secondary crosslinking.

In the former case, the electrical connection and the mechanical fixing are achieved simultaneously with the press insertion of the shaft 3.

In the latter case, the thermosetting adhesive agent is cured when the tubular body is secondarily crosslinked by the heating in the oven. Thus, the shaft 3 is electrically connected to and mechanically fixed to the developing roller 1.

As described above, the formation of the oxide film 5 is preferably achieved by the irradiation of the outer peripheral surface 4 of the developing roller 1 with the ultraviolet radiation. That is, this method is simple and efficient, because the formation of the oxide film 5 is achieved simply through the oxidation of the BR, the CR and the NBR of the electrically conductive rubber composition present in the outer peripheral surface 4 of the developing roller 1 by irradiating the outer peripheral surface 4 with ultraviolet radiation having a predetermined wavelength for a predetermined period.

The oxide film formed by the irradiation with the ultraviolet radiation as described above is free from the problems associated with the conventional shield layer formed by applying the coating agent, and is thin enough to eliminate the possibility of the reduction in the flexibility of the developing roller 1. In addition, the oxide film is highly uniform in thickness, and ensures tight adhesion thereof.

The wavelength of the ultraviolet radiation to be used for the irradiation is preferably not less than 100 nm and not greater than 400 nm, particularly preferably not greater than 300 nm, for efficient oxidation of the BR, the CR and the NBR of the rubber composition and for the formation of the oxide film 5 excellent in the aforementioned functions. The irradiation period is preferably not shorter than 30 seconds and not longer than 30 minutes, particularly preferably not shorter than 1 minute and not longer than 15 minutes.

The oxide film 5 may be formed by other methods, or may be obviated in some case.

The Type-A durometer hardness of the developing roller 1 of the nonporous single-layer structure, which is an index of the flexibility of the developing roller 1 and is controlled by changing the proportions of the sulfur and the thiuram accelerating agent as the crosslinking component within the aforementioned ranges, is preferably not greater than 55, particularly preferably not greater than 50.

A developing roller 1 having a Type-A durometer hardness greater than the aforementioned range is liable to be less flexible and harder. Therefore, when the image formation is repeated, the developing roller is more liable to damage the toner and hence cause the fogging in a margin of a formed image.

Where the Type-A durometer hardness falls within the aforementioned range, in contrast, it is possible to impart the developing roller 1 with proper flexibility and to suppress the fogging in the margin of the formed image even if the image formation is repeated.

In order to impart the developing roller 1 with sufficient durability, the Type-A durometer hardness of the developing roller 1 is preferably not less than 45, particularly preferably not less than 48.

The loss tangent tan δ of the developing roller 1, which is an index of the viscoelasticity of the developing roller controlled by changing the proportions of the sulfur and the thiuram accelerating agent within the aforementioned ranges and is determined based on a dynamic viscoelastic property (temperature variance), is preferably not greater than 0.07, particularly preferably not greater than 0.065, at 23° C.

A developing roller 1 having a loss tangent tan δ greater than the aforementioned range has lower elasticity and higher viscosity, so that the banding is liable to occur due to the uneven rotation of the developing roller driving mechanism.

Where the loss tangent tan δ falls within the aforementioned range, in contrast, the developing roller has an improved elasticity, thereby advantageously suppressing the banding,

In order to impart the developing roller 1 with proper flexibility, the loss tangent tan δ of the developing roller 1 is preferably not less than 0.35, particularly preferably not less than 0.4.

The inventive developing roller 1 can be advantageously used in an electrophotographic image forming apparatus such as a laser printer, an electrostatic copying machine, a plain paper facsimile machine or a printer-copier-facsimile multifunction machine.

### EXAMPLES

### Example 1

### (Preparation of Electrically Conductive Rubber Composition)

The following four rubbers were used as a rubber component:

40 parts by mass of a GECO (EPION (registered trade name) 301L available from Osaka Soda Co., Ltd. and having a molar ratio of EO/EP/AGE=73/23/4);

40 parts by mass of a BR (JSR BR01 available from JSR Co., Ltd. and having a cis-1,4 bond content of 95 mass % and a Mooney viscosity ML₁₊₄ (100° C.) of 45);

10 parts by mass of a CR (SHOPRENE (registered trade name) WRT available from Showa Denko K. K.); and

10 parts by mass of an NBR (lower acrylonitrile content NBR Nipol (registered trade name) DN401LL available from Nippon Zeon corporation and having an acrylonitrile content of 18% and a Mooney viscosity ML₁₊₄ (100° C.) of 32).

While 100 parts by mass of the rubber component including the four rubbers was simply kneaded by means of a Banbury mixer, ingredients other than the crosslinking component shown below in Table 1 were added to and kneaded with the rubber component. Then, the crosslinking component was finally added to and kneaded with the resulting mixture. Thus, an electrically conductive rubber composition was prepared.

TABLE 1

| Ingredients | Parts by mass |
|---|---|
| Sulfur | 0.75 |
| Thiuram accelerating agent | 0.45 |
| Thiazole accelerating agent | 1.5 |
| Thiourea accelerating agent | 0.9 |
| Guanidine accelerating agent | 0.55 |
| Acceleration assisting agent | 3 |
| Electrically conductive filler | 8 |
| Processing aid | 0.5 |
| Acid accepting agent | 1.5 |

The ingredients shown in Table 1 are as follows. The amounts (parts by mass) of the ingredients shown in Table 1 are based on 100 parts by mass of the overall rubber component. The amount of the sulfur is the effective amount of sulfur contained in the following dispersive sulfur.
Sulfur: Dispersive sulfur (SULFAX PS (trade name) available from Tsurumi Chemical Industry Co., Ltd. and having a sulfur content of 99.5%)
Thiuram accelerating agent: Tetramethylthiuram monosulfide (TMTM, SANCELER (registered trade name) TS available from Sanshin Chemical Industry Co., Ltd.)
Thiazole accelerating agent: Di-2-benzothiazyl disulfide (MBTS, SUNSINE MBTS (trade name) available from Shandong Shanxian Chemical Co., Ltd.)
Thiourea accelerating agent: Ethylene thiourea (2-mercaptoimidazoline, EU, ACCEL (registered trade name) 22-S available from Kawaguchi Chemical Industry Co., Ltd.)
Guanidine accelerating agent: 1,3-di-o-tolylguanidine (DOTG, SANCELER DT available from Sanshin Chemical Industry Co., Ltd.)
Acceleration assisting agent: Zinc oxide Type-2 (available from Mitsui Mining & Smelting Co., Ltd.)
Electrically conductive filler: Electrically conductive carbon black (Acetylene black, DENKA BLACK (registered trade name) particles available from Denki Kagaku Kogyo K. K.)
Processing aid: Zinc stearate (SZ-2000 available from Sakai Chemical Industry Co., Ltd.)
Acid accepting agent: Hydrotalcites (DHT-4A (registered trade name) 2 available from Kyowa Chemical Industry Co., Ltd.)

### (Production of Developing Roller)

The rubber composition was fed into an extruder, and extruded into a tubular body having an outer diameter of 20 mm and an inner diameter of 7.0 mm. Then, the tubular body was fitted around a temporary crosslinking shaft, and crosslinked in a vulcanization can at 160° C. for 1 hour.

Then, the crosslinked tubular body was removed from the temporary shaft, then fitted around a shaft having an outer diameter of 7.5 mm and an outer peripheral surface to which an electrically conductive thermosetting adhesive agent was applied, and heated in an oven at 160° C. Thus, the tubular body was bonded to the shaft.

In turn, opposite end portions of the tubular body were cut, and the outer peripheral surface of the resulting tubular body was traverse-polished by means of a cylindrical polishing machine, and then mirror-polished to an outer diameter of 20.00 mm (with a tolerance of 0.05). For the mirror-polishing, a #2000 lapping film (MIRROR FILM (registered trade name) available from Sankyo-Rikagaku Co., Ltd.) was used.

After the mirror-polished outer peripheral surface was washed with water, the tubular body was set in a UV irradiation apparatus (PL21-200 available from Sen Lights Corporation) with the outer peripheral surface spaced 5 cm from a UV lamp. Then, the tubular body was rotated about the shaft by 90 degrees at each time, and each 90-degree angular range of the outer peripheral surface was irradiated with ultraviolet radiation at wavelengths of 184.9 nm and 253.7 nm for 5 minutes. Thus, an oxide film was formed in the outer peripheral surface. In this manner, a developing roller was produced.

### Example 2

An electrically conductive rubber composition was prepared in substantially the same manner as in Example 1, except that the proportion of the sulfur was 0.75 parts by mass and the proportion of the thiuram accelerating agent was 0.75 parts by mass. Then, a developing roller was produced by using the electrically conductive rubber composition thus prepared.

### Example 3

An electrically conductive rubber composition was prepared in substantially the same manner as in Example 1, except that the proportion of the sulfur was 1.5 parts by mass and the proportion of the thiuram accelerating agent was 0.25 parts by mass. Then, a developing roller was produced by using the electrically conductive rubber composition thus prepared.

### Example 4

An electrically conductive rubber composition was prepared in substantially the same manner as in Example 1, except that the proportion of the sulfur was 1.5 parts by mass and the proportion of the thiuram accelerating agent was 0.75 parts by mass. Then, a developing roller was produced by using the electrically conductive rubber composition thus prepared.

### Example 5

An electrically conductive rubber composition was prepared in substantially the same manner as in Example 1, except that the proportion of the sulfur was 2 parts by mass and the proportion of the thiuram accelerating agent was 0.25 parts by mass. Then, developing roller was produced by using the electrically conductive rubber composition thus prepared.

### Example 6

An electrically conductive rubber composition was prepared in substantially the same manner as in Example 1, except that the proportion of the sulfur was 1 part by mass and the proportion of the thiuram accelerating agent was 0.5 parts by mass. Then, developing roller was produced by using the electrically conductive rubber composition thus prepared.

### Example 7

An electrically conductive rubber composition was prepared in substantially the same manner as in Example 1, except that the proportion of the sulfur was 2.25 parts by mass and the proportion of the thiuram accelerating agent was 0.25 parts by mass. Then, a developing roller was produced by using the electrically conductive rubber composition thus prepared.

### Comparative Example 1

An electrically conductive rubber composition was prepared in substantially the same manner as in Example 1, except that the proportion of the sulfur was 0.74 parts by mass and the proportion of the thiuram accelerating agent was 0.24 parts by mass. Then, a developing roller was produced by using the electrically conductive rubber composition thus prepared.

### Comparative Example 2

An electrically conductive rubber composition was prepared in substantially the same manner as in Example 1, except that the proportion of the sulfur was 2.26 parts by mass and the proportion of the thiuram accelerating agent was 0.76 parts by mass. Then, a developing roller was produced by using the electrically conductive rubber composition thus prepared.

### <Measurement of Type-A Durometer Hardness>

The type-A durometer hardness of each of the developing rollers produced in Examples and Comparative Examples was measured at a measurement temperature of 23±2° C. by the following measurement method.

Opposite end portions of a shaft projecting from opposite ends of the developing roller were fixed to a support base. In this state, an indenter point of a type-A durometer conforming to Japanese Industrial Standards JIS K6253-3:2012 “Rubber, vulcanized or thermoplastic—Determination of hardness—Part 3: Durometer method” was pressed against a widthwise middle portion of the developing roller from above, and the type-A durometer hardness of the developing roller was measured with a load of 1000 g applied to a press surface for a measurement period of 3 seconds (standard measurement period for vulcanized rubber).

A developing roller having a type-A durometer hardness of not greater than 55 was rated as acceptable (∘), and a developing roller having a type-A durometer hardness of greater than 55 was rated as unacceptable (×).

### <Measurement of Viscoelasticity>

The electrically conductive rubber compositions prepared in Examples and Comparative Examples were each formed into a sheet, which was in turn crosslinked at 160° C. for 1 hour. A strip-shaped sample having a width of 5 mm, a length of 20 mm and a thickness of 2 mm was prepared by stamping the crosslinked sheet.

The sample was set in a dynamic viscoelasticity measuring apparatus (Rheogel-E4000 available from UBM Co., Ltd.), and the loss tangent tan δ of the sample at 23° C. was determined based on the results of the measurement of the dynamic viscoelastic property (temperature variance) under the following conditions.
Measurement temperature: −150° C. to 50° C.
Temperature increase rate: 4° C./min
Measurement temperature increment: 4° C.
Measurement frequency: 2 Hz
Initial strain: Constant
Amplitude: 50 μm
Deformation mode: Stretching mode
Inter-chuck distance: 20 mm
Waveform: Sine wave

A sample having a loss tangent tan δ of not greater than 0.07 was rated as acceptable (∘), and a sample having a loss tangent tan δ of greater than 0.07 was rated as unacceptable (×).

### <Actual Machine Test>

A new toner cartridge (including a toner container containing toner, a photoreceptor body, and a developing roller kept in contact with the photoreceptor body) for a commercially available laser printer was prepared, and the developing rollers produced in Examples and Comparative Examples were each incorporated in the cartridge instead of the original developing roller.

The laser printer was capable of sequentially forming images at an image density of 5% at an image formation rate of 40 images/min on up to 6500 sheets (printer life) with the use of a positively-chargeable nonmagnetic single-component toner of grinding type.

### (Evaluation for Imaging Durability)

The aforementioned cartridge was mounted in the laser printer in the initial state, and images were sequentially formed at an image density of 1% at a temperature of 23±2° C. at a relative humidity of 55±2%. Every 500th image was checked for the fogging in a margin thereof until the end of the printer life, and the developing roller was evaluated for the imaging durability based on the following criteria.
∘(Excellent imaging durability): The fogging was not observed until the end of the printer life,
×(Poor imaging durability): The fogging was observed by the end of the printer lift.
   (Evaluation against Banding)

The aforementioned cartridge was mounted in the laser printer in the initial state, and an entirely solid image and an entirely halftone image were formed at a temperature of 23±2° C. at a relative humidity of 55±2%.

The images were each checked for the banding (i.e., repetitive streaks formed in the image at a pitch of 1 to 5 mm as extending perpendicularly to a sheet feeding direction due to density variation irrespective of the rotation cycle of the developing roller), and the developing roller was evaluated against the banding based on the following criteria.
∘(Excellent) : The banding was observed neither in the entirely solid image nor in the entirely halftone image.
δ(Acceptable) : The banding was observed in the entirely solid image, but not observed in the halftone image.
×(Unacceptable): The banding was observed in both the entirely solid image and the entirely halftone image.

The results are shown in Tables 2 and 3.

TABLE 2

| | | | | |
|---|---|---|---|---|
| Comparative | | | | Exam- |
| Example 1 | Example 1 | Example 2 | Example 3 | ple 4 |

Parts by mass
Rubber component

| | | | | | |
|---|---|---|---|---|---|
| GECO | 40 | 40 | 40 | 40 | 40 |
| BR | 40 | 40 | 40 | 40 | 40 |
| CR | 10 | 10 | 10 | 10 | 10 |
| NBR | 10 | 10 | 10 | 10 | 10 |
| Sulfur | 0.74 | 0.75 | 0.75 | 1.5 | 1.5 |
| Thiuram | 0.24 | 0.45 | 0.75 | 0.25 | 0.75 |
| accelerating | | | | | |
| agent | | | | | |

Evaluation
Type-A hardness

| | | | | | |
|---|---|---|---|---|---|
| Value | 47 | 48 | 50 | 50 | 53 |
| Rating | ∘ | ∘ | ∘ | ∘ | ∘ |

Loss tangent tanδ

| | | | | | |
|---|---|---|---|---|---|
| Value | 0.077 | 0.07 | 0.06 | 0.066 | 0.049 |
| Rating | x | ∘ | ∘ | ∘ | ∘ |

Actual machine test

| | | | | | |
|---|---|---|---|---|---|
| Fogging | ∘ | ∘ | ∘ | ∘ | ∘ |
| Banding | x | Δ | ∘ | ∘ | ∘ |

TABLE 3

| | | | |
|---|---|---|---|
| | | | Comparative |
| Example 5 | Example 6 | Example 7 | Example 2 |

Parts by mass
Rubber component

| | | | | |
|---|---|---|---|---|
| GECO | 40 | 40 | 40 | 40 |
| BR | 40 | 40 | 40 | 40 |
| CR | 10 | 10 | 10 | 10 |
| NBR | 10 | 10 | 10 | 10 |
| Sulfur | 2 | 1 | 2.25 | 2.26 |
| Thiuram accelerating | 0.25 | 0.5 | 0.25 | 0.76 |
| agent | | | | |

Evaluation
Type-A hardness

| | | | | |
|---|---|---|---|---|
| Value | 52 | 49 | 53 | 56 |
| Rating | ∘ | ∘ | ∘ | x |

Loss tangent tanδ

| | | | | |
|---|---|---|---|---|
| Value | 0.059 | 0.065 | 0.056 | 0.038 |
| Rating | ∘ | ∘ | ∘ | ∘ |

Actual machine test

| | | | | |
|---|---|---|---|---|
| Fogging | ∘ | ∘ | ∘ | x |
| Banding | ∘ | ∘ | ∘ | ∘ |

The results for Examples 1 to 7 and Comparative Examples 1 and 2 shown in Tables 2 and 3 indicate that, where the inventive electrically conductive rubber composition is used which contains the rubber component including the epichlorohydrin rubber, the BR, the CR and the NBR, and 0.75 to 2.25 parts by mass of the sulfur and 0.25 to 0.75 parts by mass of the thiuram accelerating agent based on 100 parts by mass of the overall rubber component, the developing roller can be imparted with proper flexibility without the use of the softening agent without the formation of the shield layer, so that an image formed by using the developing roller is substantially free from the banding, the fogging and other defects.

The results for Examples 1 to 7 indicate that, for further improvement of the aforementioned effects, the total proportion of the sulfur and the thiuram accelerating agent is preferably not less than 1.3 parts by mass and not greater than 2.0 parts by mass, particularly preferably not less than 1.5 parts by mass and not greater than 1.75 parts by mass, based on 100 parts by mass of the overall rubber component.

This application corresponds to Japanese Patent Application No. 2015-243326 filed in the Japan Patent Office on Dec. 14, 2015, the disclosure of which is incorporated herein by reference in its entirety.

What is claimed is:

1. An electrically conductive rubber composition comprising:
a rubber component; and
a crosslinking component for crosslinking the rubber component;
wherein the rubber component comprises an epichlorohydrin rubber, a butadiene rubber, a chloroprene rubber and an acrylonitrile butadiene rubber;
wherein the crosslinking component comprises not less than 0.75 parts by mass and not greater than 2.25 parts by mass of sulfur and not less than 0.25 parts by mass and not greater than 0.75 parts by mass of a thiuram accelerating agent based on 100 parts by mass of the overall rubber component.

2. The electrically conductive rubber composition according to claim 1, wherein the crosslinking component further comprises at least one selected from the group consisting of not less than 0.75 parts by mass and not greater than 2 parts by mass of a thiazole accelerating agent, not less than 0.5 parts by mass and not greater than 1.5 parts by mass of a thiourea accelerating agent, and not less than 0.1 part by mass and not greater than 1 part by mass of a guanidine accelerating agent.

3. A developing roller comprising a crosslinking product of the electrically conductive rubber composition according to claim 1.

4. The developing roller according to claim 3, which has a Type-A durometer hardness of not greater than 55, and a loss tangent tan δ of not greater than 0.07 as determined at 23° C. based on a dynamic viscoelastic property (temperature variance).

5. The developing roller according to claim 3, which has an oxide film in an outer peripheral surface thereof.

6. The developing roller according to claim 4, which has an oxide film in an outer peripheral surface thereof.

7. A developing roller comprising a crosslinking product of the electrically conductive rubber composition according to claim 2.

8. The developing roller according to claim 7, which has a Type-A durometer hardness of not greater than 55, and a loss tangent tan δ of not greater than 0.07 as determined at 23° C. based on a dynamic viscoelastic property (temperature variance).

9. The developing roller according to claim 7, which has an oxide film in an outer peripheral surface thereof.

10. The developing roller according to claim 8, which has an oxide film in an outer peripheral surface thereof.
